(19) United States
(12) Patent Application Publication
(10) Pub. No.: US 2026/0336024 A1
(43) Pub. Date: Oct. 29, 2026

(54) METHOD FOR CUTTING BLANKS HAVING A PREDETERMINED DESIRED CONTOUR AND TEMPERATURE COMPENSATION

(71) Applicant: ANDRITZ Schuler Pressen GmbH, Göppingen (DE)

(72) Inventors: Alexander SEITZ, Erlangen (DE); Rolf CISAR, Engelthal (DE)

(21) Appl. No.: 19/121,439

(22) PCT Filed: Apr. 26, 2024
(86) PCT No.: PCT/EP2024/061563

§ 371 Date: Apr. 16, 2025

(30) Foreign Application Priority Data
May 16, 2023 (DE) 10 2023 112 933.3

(51) Int. Cl. B23K 26/08; B23K 26/38; G01B 3/12; G01K 1/02; G01K 3/06

(52) U.S. Cl. CPC B23K 26/0876; B23K 26/38; G01B 3/12; G01K 1/026; G01K 3/06

(57) ABSTRACT

The invention relates to a method for cutting blanks (P) having a predetermined desired contour from a metal strip (1) that is continuously conveyed in a transport direction (x). In order to improve the cutting precision, it is proposed according to the invention that the desired contour is related to precisely one reference temperature (T_{R}) of the blank (P), that a first current temperature (T1) of the metal strip (1) is measured, that, in order to produce the desired contour, the cutting path (xy) is adjusted in a second algorithm to an adjusted cutting path (xy-korr) according to the first temperature (T1) with respect to the reference temperature (T_{R}), and that the transport path (xₐ) of the metal strip (1) is adjusted according to a third algorithm to an adjusted transport path (Xa-korr) according to the first current temperature (T1) with respect to the reference temperature (T_{R}).

### TECHNICAL FIELD

The invention relates to a method for cutting blanks with a predetermined nominal contour according to the preamble of claim 1.

### BACKGROUND

Such a method is known, for example, from WO 2016/135350 A1.

According to the known method, sheet metal blanks or plates are cut from a sheet metal strip transported continuously in one transport direction by means of several laser cutting devices arranged one behind the other. Each of the laser cutting devices produces a partial cut along a predetermined cutting path. The cutting path is defined by cutting path coordinates. In practice, the sheet metal strip may not be transported exactly in the transport direction or x axis direction. As a result, it is necessary to correct the cutting path coordinates. For this purpose, the coordinates of a point on a surface of the sheet metal strip are determined in relation to a reference point. Furthermore, to determine the cutting path coordinates to be corrected, a path measuring device is provided for measuring a transport path of the sheet metal strip.

The known method enables a relatively precise correction of a cutting path so that the ends of the partial cuts surrounding a blank merge largely exactly into one another. Reworking the blank in the area of overlapping ends of partial cuts can be carried out using the known method with considerably less effort.

Until now, blanks made of aluminum or steel sheet were usually produced from a continuously transported sheet metal strip using laser cutting processes. Any necessary reworking of such blanks was possible with reasonable effort. This was not easily possible with high-strength sheet metal.

Recently, there has been a requirement to produce sheet metal whose contour corresponds exactly to a specified target contour, at least in sections.

### SUMMARY OF INVENTION

It is the object of the invention to eliminate the disadvantages of the prior art. In particular, a method for manufacturing blanks which correspond largely exactly to a predetermined nominal contour is to be specified.

This object is solved by the features of claim 1. Expedient embodiments of the invention result from the features of the dependent claims.

### Definitions

### Transport Path (xₐ)

Feed path of the sheet metal strip in the transport direction or x axis direction. The transport path xₐ is formed from successive transport path data. The transport path data is calculated using a first algorithm (see below).

### Cutting Path (xy)

The cutting path xy is calculated from CAD data that describes the target contour of the blank. The calculation is carried out using the first algorithm. Each transport path datum is assigned exactly one pair of cutting path coordinates. The cutting path coordinate pair is used to control an xy movement device, e.g. a gantry, to which a cutting laser is attached. The cutting path xy can also be divided into several cutting path sections to create partial cuts. In this case, the respective cutting path sections can be cut using different cutting lasers. For example, a first cutting path section can be cut using a first cutting laser and a second cutting path section can be cut using a second cutting laser arranged downstream of the first cutting laser.

### Laser Cutting Device (LS)

comprises at least one cutting laser, which is mounted on an xy movement device and can be moved in the x axis direction and a y axis direction perpendicular to it under computer control.

### Working Area (A1, A2)

xy range in which a cutting laser can generate cutting paths or cutting path sections.

### Reference Temperature (TR)

temperature at which the blank has the specified target contour, for example the temperature of a measuring chamber in which the target contour of the blank is measured.

### First Current Temperature (T1)

current temperature of the sheet metal strip; preferably, the first current temperature is measured upstream of a cutting laser of the laser cutting device.

### First Algorithm

calculates the transport path (xₐ) and xy values, which describe the cutting path, from CAD data and process parameters.

### Second Algorithm

calculates corrected xy values from the xy values and the first current temperature (T1), which are provided to the xy movement device for moving the cutting laser along a corrected cutting path (xy-corr).

### Third Algorithm

Calculates a corrected transport path (xₐ-corr) from the transport path (xₐ) and the first current temperature (T1).

### x or y Measuring Device (LX1, LX2, LY1, LY2)

device for determining a position or measuring a distance of a cutting laser in the x axis or y axis direction, e.g. a linear measuring device with a glass rod.

### x or y Reference Point (RX1, RX2, RY1, RY2)

specified reference point of the x or y measuring device, e.g. attachment point of the x or y measuring device on a machine frame.

### Machine Frame

frame to which the laser cutting device is attached.

### Machine Frame Reference Point (RMG)

specified reference point on the machine frame.

### Second Current Temperature (T2)

temperature, which is measured in the area of the laser cutting device. The measurement of the second current temperature is used to determine the temperature of the machine frame; it can be measured directly on the machine frame and/or indirectly in the vicinity of the machine frame.

### First Calibration Temperature (TK1)

the temperature at which the x and y measuring devices have a predetermined distance from the machine frame reference point (RMG).

### Second/Third Calibration Temperature (TK2/TK3)

device-specific temperatures for which distance measurements carried out with the x measuring devices are calibrated.

### Fourth/Fifth Calibration Temperature (TK4/TK5)

device-specific temperatures for which distance measurements carried out with the y-measuring devices are calibrated.

### Sixth Calibration Temperature (TK6)

specified temperature at which a fixed point of a strip edge sensor has a predetermined distance from the machine frame reference point (RMG).

### Seventh Calibration Temperature (TK7)

device-specific temperature for which a displacement measured with the measuring wheel is calibrated.

### Third Current Temperature (T3)

temperature, which is measured in the area of the position sensor. The measurement of the third current temperature is used to determine the temperature of the position sensor; it can be measured directly on the position sensor and/or indirectly in the vicinity of the position sensor.

### Target Contour

the target contour is the outline of a single blank in plan view. The target contour of a PCB is usually defined by CAD data, which is available as a data set. The target contour usually refers to a reference temperature of 20 °C. This means that a PCB corresponds exactly to the target contour if it has a temperature of 20 °C

Laser cutting systems for cutting blanks from a continuously transported sheet metal strip usually have a considerable length of 5 m or more. Such laser cutting systems are usually set up in large halls in which the manufactured blanks are transported away on conveyor belts and stored temporarily. Such halls are not usually kept at a certain predetermined temperature. The halls may be equipped with windows through which sunlight falls on sections of the laser cutting system(s). The temperature may vary along a laser cutting line. Sheet metal coils are often brought in from storage halls, which in turn have a temperature that is different from the temperature of the laser cutting system. Overall, there are temperature fluctuations between the sheet metal coil and a downstream end of the sheet metal strip, which counteract the high-precision production of blanks with a specified target contour.

The proposed method has been created on the basis of this knowledge. It is proposed according to the invention,

that the target contour is related to exactly one reference temperature of the blank,

that a first current temperature of the metal strip is measured,

the cutting path is corrected into a corrected cutting path in a second algorithm as a function of the first current temperature with respect to the reference temperature in order to produce the target contour, and

that the transport path of the sheet metal strip is corrected into a corrected transport path according to a third algorithm depending on the first current temperature in relation to the reference temperature.

According to the method according to the invention, the target contour is based on precisely one specified reference temperature. This reference temperature can, for example, be the temperature at which the target contour is described by the CAD data. This could be 20 °C, for example.

According to the first algorithm, cutting path coordinates or machine coordinates are generated from the CAD data, which describe the cutting path (xy). Corresponding transport path data is also generated, which describes the transport path or a target transport path. The first algorithm advantageously results in a table in which the corresponding xy values are assigned to each transport path datum. Each transport path date has a predefined distance in relation to a subsequent transport path date. The corresponding xy values are interpolated between two consecutive transport path dates.

According to the invention, a first current temperature of the sheet metal strip is measured. By means of a second algorithm, the cutting path coordinates describing the cutting path (xy) or the cutting path (xy) are then corrected into a corrected cutting path (xy-corr) as a function of the first current temperature with respect to the reference temperature. For example, a blank contour produced at a temperature of 30 °C according to the corrected cutting path is larger than the target contour. Only when such a blank is cooled down to the reference temperature does its dimension change so that it corresponds to the target contour.

According to further provisions of the invention, the transport path of the sheet metal strip is corrected into a corrected transport path according to a third algorithm as a function of the first current temperature with respect to the reference temperature. This takes account of the fact that the length of the sheet metal strip changes upstream of the laser cutting device due to a temperature deviating from the reference temperature. Due to the proposed correction of the transport path data describing the transport path according to the invention, it is ensured that the required cuts can actually be made within a working range of the laser cutting device. Without the proposed correction of the transport path, it is possible that cuts or partial cuts may shift within the laser cutting device and thus the desired cuts or partial cuts within the respective working area are no longer possible.

The correction of the cutting path and the further correction of the transport path make it possible to produce a blank that has exactly the specified target contour. According to the proposed method, a large number of such blanks can be produced very efficiently from a continuously moving sheet metal strip.

According to an advantageous embodiment, the laser cutting device can have a first working area, wherein the first working area has a first x measuring device for determining an x axis position of a first cutting laser, wherein a first x-reference point is assigned to the first x measuring device, wherein a second current temperature is measured in the area of the laser cutting device x measuring device for determining an x position of a first cutting laser, wherein a first x reference point is assigned to the first x measuring device, wherein a second current temperature is measured in the region of the laser cutting device, and wherein an x distance between the first x reference point and a machine frame reference point is corrected as a function of the second current temperature with respect to a predetermined first calibration temperature.

A laser cutting device comprises a first cutting laser, which is attached to a gantry, for example. By means of the gantry, the first cutting laser can be moved back and forth in a first working area in the x axis direction and in the y axis direction. The laser cutting device also has a housing in which the at least one cutting laser is accommodated. The housing is essentially used to prevent unwanted laser beams from escaping into the environment. Due to the housing, the temperature inside the laser cutting device is sometimes different from that in the environment. As a result, temperature-related deviations also occur in the area of the laser cutting device, particularly when positioning the cutting lasers. To correct such deviations, it is proposed to measure a second current temperature in the area of the laser cutting device. The position of a cutting laser in the x axis direction is measured by a first x-measuring device. The x-measuring device is permanently connected to the machine frame at one point. A machine frame reference point is defined on the machine frame. A distance between the machine frame reference point and the attachment point of the x-measuring device on the machine frame is known exactly for a first calibration temperature. The x-measuring device measures x-values exactly when the first calibration temperature prevails. Changes in the distance as a result of a second actual temperature deviating from the first calibration temperature are compensated for according to the proposed advantageous embodiment by correcting an x axis distance between the first x reference point and a machine frame reference point as a function of the second actual temperature with respect to the specified first calibration temperature.

The laser cutting device can have not only one cutting laser, but also several cutting lasers. Advantageously, the laser cutting device has a second working area downstream of the first working area, wherein the second working area has a second x-measuring device for determining an x-position of a second cutting laser, wherein a second x-reference point is assigned to the second x-measuring device, wherein an x axis distance between the second x-reference point and the machine frame is determined. X measuring device is assigned a second x reference point, an x distance between the second x reference point and the machine frame reference point being corrected as a function of the second current temperature with respect to the first calibration temperature.

Apart from the first calibration temperature, each x-measuring device has a device-specific calibration temperature for which the x-values supplied by the respective x-measuring device are valid. If x measuring devices are at a temperature that deviates from the respective device-specific calibration temperature, the x values supplied by them must be corrected. For example, if a linear scale is used as the x-measuring device, one length of the linear scale is calibrated to a second calibration temperature. Accordingly, it is advantageously proposed that the first x-measuring device has a predetermined second calibration temperature and is corrected using the second actual temperature with respect to the second calibration temperature and/or the second x-measuring device has a predetermined third calibration temperature and is corrected using the second actual temperature with respect to the third calibration temperature.

The suggested corrections of the x-measuring device(s) contribute to a particularly precise production of blanks according to the target contour.

According to the proposed corrections of the x-measuring devices, first and/or second y-measuring devices can advantageously also be corrected in an analogous manner. For this purpose, the first working area can have a first y-measuring device for determining a y-position of a first cutting laser, wherein a first y-reference point is assigned to the first y-measuring device, and wherein a y axis distance between the first y-reference point and the machine frame reference point is corrected as a function of the second current temperature with respect to the first calibration temperature. According to the proposed embodiment, the first y measuring device is corrected analogously to the first x measuring device with respect to its first y reference point and the machine frame reference point as a function of the second current temperature with respect to the first calibration temperature.

Advantageously, the second working area has a second y-measuring device for determining a y-position of the second cutting laser, wherein a second y-reference point is assigned to the second y-measuring device, wherein a y axis distance between the second y-reference point and the machine frame reference point is corrected as a function of the second current temperature with respect to the first calibration temperature.

As with the x measuring devices, the y measuring devices can also have device-specific calibration temperatures for which they provide exact y measured values. If there is a deviation from these specific calibration temperatures, the y measured values supplied must be corrected. Advantageously, the first y-measuring device has a predetermined fourth calibration temperature and the first y-measuring device is corrected using the second current temperature with respect to the fourth calibration temperature and/or the second y-measuring device has a predetermined fifth calibration temperature and the second y-measuring device is corrected using the second current temperature with respect to the fifth calibration temperature. This enables a particularly precise production of blanks according to their specified target contour.

According to a further advantageous embodiment, several temperature sensors are used to measure one or more of the current temperatures and an average value from the values measured with the temperature sensors is used as the current temperature. This can further increase the precision of the proposed method.

According to a further advantageous embodiment, strip edge sensors are provided for detecting the y-positions of strip edges of the sheet metal strip, wherein the strip edge sensors are provided with a device for adjusting the respective measuring position in the y axis direction, wherein the measuring positions of the strip edge sensors are corrected as a function of the second current temperature with respect to a sixth calibration temperature. Strip edge sensors usually have a relatively small measuring range. Their measuring position can be adjusted in the y axis direction by means of a device for adjusting the respective measuring position. The term “measuring position” refers to a fixed point of the respective strip edge sensor in relation to the machine frame reference point. The measuring positions of the strip edge sensors can advantageously be corrected as a function of the second current temperature with respect to the sixth calibration temperature. In other words, a distance between the machine frame reference point and the respective measuring position in the y axis direction is corrected as a function of the second current temperature with respect to the sixth calibration temperature.

It is expedient to measure an actual transport path by means of a path measuring device and use the actual transport path as the actual value to control the transport path. For example, a measuring wheel is used as a distance measuring device, whereby a diameter of the measuring wheel is corrected as a function of a third current temperature with respect to a specified seventh calibration temperature. A third current temperature of the measuring wheel is measured to correct the x-values supplied by the measuring wheel. A diameter of the measuring wheel is corrected with respect to a seventh calibration temperature specified for the measuring wheel. This ensures that the x-values supplied by the measuring wheel are corrected for temperature fluctuations.

The first and/or third current temperature is/are conveniently measured upstream of the laser cutting device. This allows temperature differences along a laser cutting line to be taken into account.

### BRIEF DESCRIPTION OF DRAWINGS

In the following, embodiments of the invention are explained in more detail with reference to the drawings. They show:

FIG. 1 shows a schematic overview of the main components of a laser cutting system,

FIG. 2 shows a schematic overview of a laser cutting system with strip edge sensors,

FIG. 3 shows a block diagram, and

FIG. 4 shows schematically the effect of the method according to the invention.

### DETAILED DESCRIPTION OF THE INVENTION

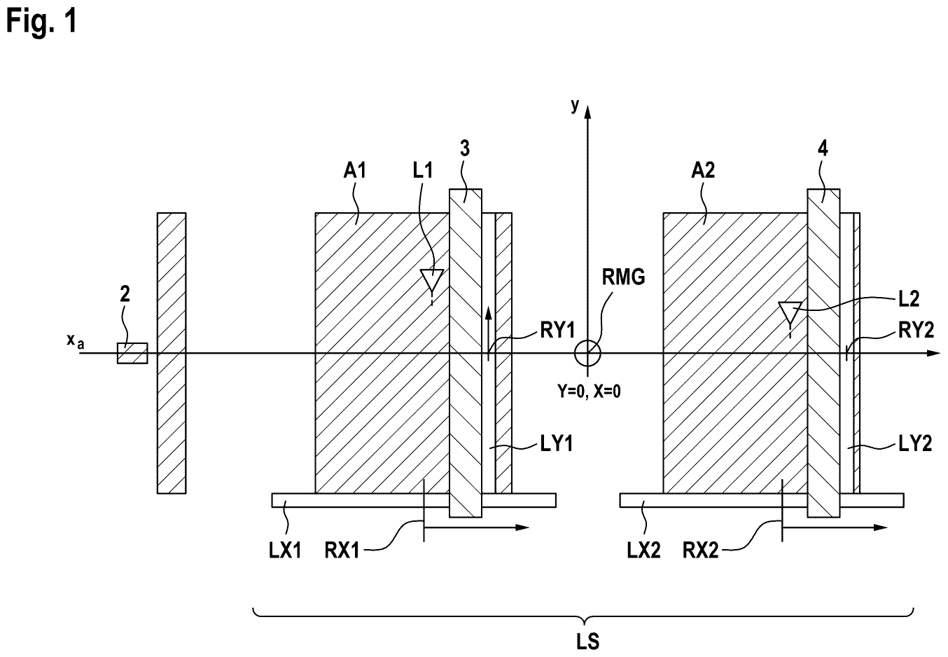

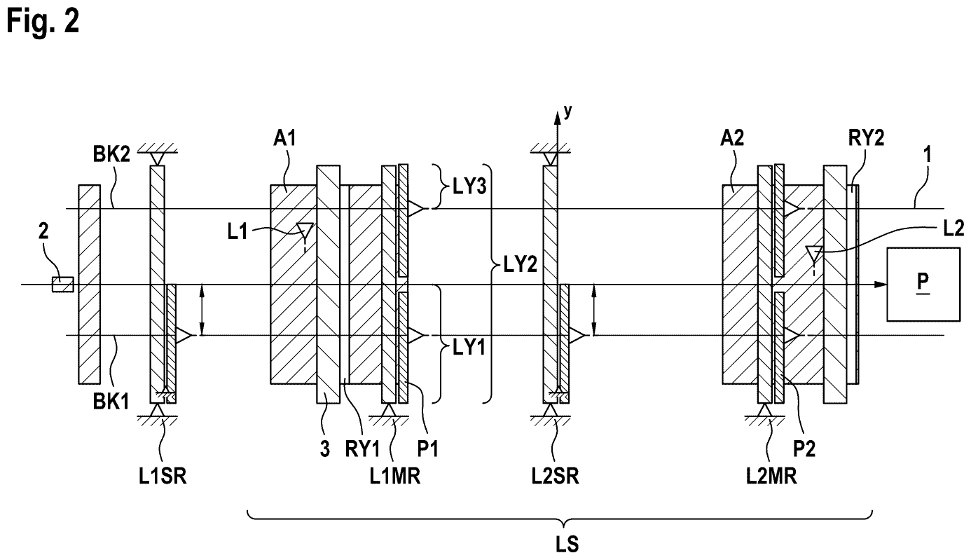

FIG. 1 and FIG. 2 schematically show components of a laser cutting system. The reference sign 1 (see FIG. 2) indicates a sheet metal strip that is transported continuously in an x axis direction or transport direction.

A conveyor device (not shown here), which is located upstream of a displacement measuring device 2, can be used to transport the sheet metal strip 1. The conveyor can be a roll straightening machine or a roll feed, for example. The displacement measuring device 2 can be a measuring wheel, for example.

A blank P (see FIG. 2), which is shown downstream of a laser cutting device LS, has a rectangular contour.

The laser cutting device LS comprises a first cutting laser L1, which is attached to a first gantry 3 (not shown here) so that it can be moved in the x and y directions. The first cutting laser L1 can be moved in the first working area A1 in the x and y directions. To determine an x-position of the first cutting laser L1, a first x-measuring device LX1 is provided, which can, for example, be an optical measuring device with a linear scale. The first x-measuring device LX1 is attached to a machine frame (not shown here in detail) at a first x-reference point RX1. To measure a first y-position of the first cutting laser L1, a first y-measuring device LY1 is provided, which is attached to the machine frame (not shown here) at a first y-reference point RY1.

A second cutting laser L2 is provided downstream of the first cutting laser L1, which can be moved back and forth in the x and y directions in the same way as the first cutting laser L1 by means of a second gantry 4 in a second working area A2. A second x-measuring device is designated by the reference sign LX2 and a second x-reference point by the reference sign RX2. A second y-measuring device is designated by the reference sign LY2 and a second y-reference point by the reference sign RY2. A machine frame reference point is designated by the reference sign RMG.

The strip edge sensors are shown in more detail in FIG. 2. The sheet metal strip 1 has a first strip edge BK1 and a second strip edge BK2. A first stationary strip edge sensor L1SR is provided upstream of the first working area A1 and a second stationary strip edge sensor L2SR is provided between the first working area A1 and the second working area A2. A first moving strip edge sensor L1MR is provided within the first working area A1, which can be moved along a first positioning axis P1 in the y axis direction. A second traveling strip edge sensor L2MR is provided within the second working area A2, which can be moved along a second positioning axis P2 in the y axis direction.

The strip edge sensors L1SR, L2SR, L1MR, L2MR shown here are each only shown for the first strip edge BK1. For the sake of clarity, further strip edge sensors arranged opposite each other to determine the position of the second strip edge BK2 are omitted.

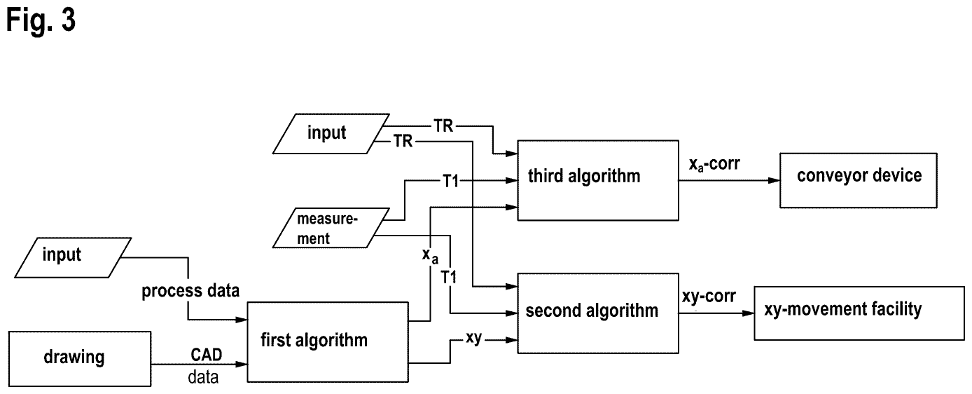

The process is now explained in more detail in conjunction with the block diagram shown in FIG. 3.

A target contour of a PCB P to be manufactured is initially defined by CAD data. A corresponding data set of the CAD data is transferred to a first algorithm. Furthermore, process data, such as a thickness of a sheet to be cut, a cutting speed, material properties, a maximum transport path, a maximum width of the sheet and the like, are transferred to the first algorithm. Based on this data, a transport path xₐ and cutting path coordinates xy are calculated using the first algorithm. The cutting path coordinates xy are control data for controlling the movements of the first cutting laser L1 and the second cutting laser L2 by means of the respective gantries 3, 4. According to the invention, the cutting path coordinates xy produced according to the first algorithm are now corrected in a second algorithm. The measured first current temperature T1 and the reference temperature T_{R}, for which the target contour applies, are used. The second algorithm provides a corrected cutting path xy-corr or corrected cutting path coordinates, which are used to control the movement devices or gantries 3, 4 with which the cutting lasers L1, L2 are moved.

According to the invention, the xₐ values are further corrected together with the reference temperature T_{R} and the measured first current temperature T1 in a third algorithm. The third algorithm provides a corrected path xₐ-corr. The corrected transport path xₐ-corr is used to control the conveyor system for conveying the metal strip 1 in the x axis direction.

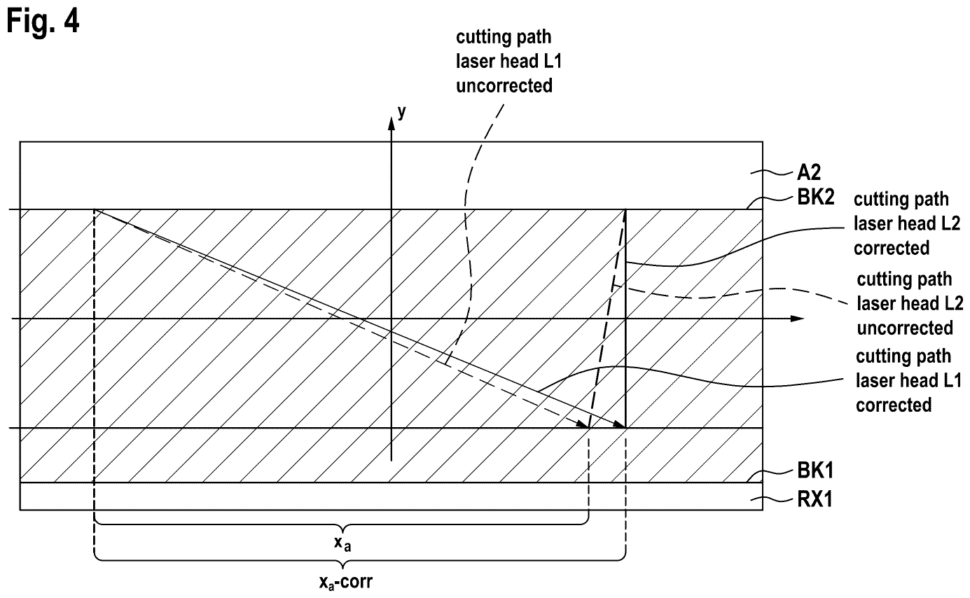

FIG. 4 schematically shows the influence of the correction of the transport path in the x axis direction. Shown is the case in which an uncorrected transport path xₐ is smaller than a corrected transport path xₐ-corr. The cutting paths indicated by broken lines refer to the transport path xₐ and the corrected cutting paths indicated by solid lines refer to the corrected transport path xₐ-corr.

It is clear from the example shown that if there is a deviation from one or more reference temperatures, the uncorrected cutting paths lead to a cutting contour that deviates significantly from the target contour.

According to the invention, a corrected cutting path and a corresponding corrected transport path are calculated as a function of the first current temperature in order to improve the accuracy of a target contour to be produced. To further improve the process, x and/or y measuring devices can be corrected with regard to their calibration temperatures using a second current temperature. Furthermore, a position of the x-and/or y-measuring devices within the working areas can be corrected with respect to the second current temperature. In this respect, temperature-related geometric deformations of a machine frame on which the x and/or y measuring devices are mounted are therefore taken into account.

In practice, the sheet metal strip 1 may move back and forth in the y axis direction during transportation in the x axis direction. Such a movement can be caused, for example, by the sheet metal strip 1 swaying. In order to also correct the cutting path data xy or xy-corr in this respect, the measuring positions of the strip edge sensors can be changed depending on the second current temperature. This allows the current position of the strip edge BK to be measured precisely. The measured values of the current position of the strip edge BK can be used to correct the cutting path coordinates xy or the corrected cutting path coordinates xy-corr. This further increases the accuracy of the proposed method.

### LIST OF REFERENCE NUMBERS

1 sheet metal strip
2 displacement measuring device
3 first gantry
4 second gantry
A1 first working area
A2 second working area
BK1 first belt edge
BK2 second belt edge
L1 first cutting laser
L1MR first traveling strip edge sensor
L2 second cutting laser
L2MR second traveling strip edge sensor
L1SR first stationary strip edge sensor
L2SR second stationary strip edge sensor
LS laser cutting device
LX1 first linear scale
LX2 second linear scale
LY1 first y-measuring device
LY2 second y-measuring device
P blank
P1 first positioning axis
P2 second positioning axis
RX1 first x-reference point
RX2 second x-reference point
RY1 first y-reference point
RY2 second y-reference point
xₐ transport path
xₐ-corr corrected transport path
xt actual transport path

1. A method for cutting blanks (P) with a predetermined nominal contour from a sheet metal strip (1) transported continuously in a transport direction (x), comprising the following steps:
providing a data set describing the target contour,
calculating a transport path (xa) and a corresponding cutting path (xy) using a first algorithm,
continuous transportation of the sheet metal strip (1) by means of a conveyor to a laser cutting device (LS) arranged downstream,
cutting the blank along at least one cutting path (xy) from the sheet metal strip (1) by means of the laser cutting device (LS),
characterized in that
the target contour is related to exactly one reference temperature (T_{R}) of the blank (P),
a first current temperature (T1) of the metal strip (1) is measured,
the cutting path (xy) is corrected in a second algorithm as a function of the first current temperature (T1) with respect to the reference temperature (T_{R}) into a corrected cutting path (xy-corr) in order to produce the desired contour, and
the transport path (xₐ) of the sheet metal strip (1) is corrected into a corrected transport path (xₐ-corr) according to a third algorithm as a function of the first current temperature (T1) with respect to the reference temperature (T_{R}).

2. The method according to claim 1, wherein the laser cutting device (LS) has a first working area (A1), wherein the first working area (A1) has a first x-measuring device (LX1) for determining an x-position of a first cutting laser (L1), wherein a first x-reference point (RX1) is assigned to the first x-measuring device (LX1), wherein a second current temperature (T2) is measured in the region of the laser cutting device (LS), and wherein an x axis distance between the first x-reference point (RX1) and a machine frame reference point (RMG) is corrected as a function of the second current temperature (T2) with respect to a predetermined first calibration temperature (TK1).

3. The method according to claim 2, wherein the laser cutting device (LS) has a second working area (A2) downstream of the first working area (A1), wherein the second working area (A2) has a second x-measuring device (LX2) for determining an x-position of a second cutting laser (L2), wherein a second x-reference point (RX2) is assigned to the second x-measuring device (LX2), and wherein an x axis distance between the second x-reference point (RX2) and the machine frame reference point (RMG) is corrected as a function of the second current temperature (T2) with respect to the first calibration temperature (TK1).

4. The method according to claim 2 or 3, wherein the first x-measuring device (LX1) has a predetermined second calibration temperature (TK2) and is corrected with respect to the second calibration temperature (TK2) using the second current temperature (T2) and/or the second x-measuring device (LX2) has a predetermined third calibration temperature (TK3) and is corrected with respect to the third calibration temperature (TK3) using the second current temperature (T2).

5. The method according to one of claims 2 to 4, wherein the first working area (A1) comprises a first y-measuring device (LY1) for determining a y-position of a first cutting laser (L1), wherein a first y-reference point (RY1) is assigned to the first y-measuring device (LY1), and wherein a y axis distance between the first y-reference point (RY1) and the machine frame reference point (RMG) is corrected as a function of the second current temperature (T2) with respect to the first calibration temperature (TK1).

6. The method according to one of claims 3 to 5, wherein the second working area (A2) comprises a second y-measuring device (LY2) for determining a y-position of a second cutting laser (L2), wherein a second y-reference point (RY2) is assigned to the second y-measuring device (LY2), and wherein a y axis distance between the second y-reference point (RY2) and the machine frame reference point (RMG) is corrected as a function of the second current temperature (T2) with respect to the first calibration temperature (TK1).

7. The method according to claim 5 or 6, wherein the first y-measuring device (LY1) has a predetermined fourth calibration temperature (KT4) and the first y-measuring device (LY1) is corrected with respect to the fourth calibration temperature (KT4) using the second current temperature (T2) and/or the second y-measuring device (LY2) has a predetermined fifth calibration temperature (KT5) and the second y-measuring device (LY2) is corrected with respect to the fifth calibration temperature (KT5) using the second current temperature (T2).

8. The method according to one of the preceding claims, wherein several temperature sensors are used to measure one or more of the current temperatures (T1, T2) and an average value from the values measured with the temperature sensors is used as the current temperature (T1, T2).

9. The method according to one of the preceding claims, wherein strip edge sensors (L1MR, L2MR) are provided for detecting the y-positions (Y1, Y2) of strip edges of the sheet metal strip (1), wherein the strip edge sensors (L1MR, L2MR) are provided with a device for adjusting the respective measuring position in the y axis direction, the measuring positions of the strip edge sensors (L1MR, L2MR) being corrected as a function of the second current temperature (T2) with respect to a sixth calibration temperature (TK6).

10. The method according to one of the preceding claims, wherein an actual transport path (xt) is measured by means of a displacement measuring device (2) and the actual transport path (xt) is used as the actual value for controlling the transport path (xa).

11. The method according to claim 10, wherein a measuring wheel is used as the displacement measuring device (2), wherein a diameter (D) of the measuring wheel is corrected as a function of a third current temperature (T3) with respect to a predetermined seventh calibration temperature (TK7).

12. The method according to any one of the preceding claims, wherein the first current temperature (T1) and/or the third current temperature (T3) is measured upstream of the laser cutting device (LS).
